(19) United States
(12) Patent Application Publication
(10) Pub. No.: US 2026/0008195 A1
(43) Pub. Date: Jan. 8, 2026

(54) BREAD SLICER

(71) Applicant: Shenzhen Tuanxin Intelligent Technology Co., Ltd., Shenzhen (CN)

(72) Inventors: Yindi Yu, Shangrao (CN); Zaofa XUE, Shangrao (CN)

(21) Appl. No.: 18/764,054

(22) Filed: Jul. 3, 2024

(51) Int. Cl. B26B 29/06

(52) U.S. Cl. CPC B26B 29/063; B26B 2029/066

(57) ABSTRACT

The present invention relates to a bread slicer, comprising: a storage box, comprising a box body, an installing frame and a cutting disk, wherein the box body is provided with an accommodating chamber, the accommodating chamber can accommodate cut bread slices, an upper end of the accommodating chamber has a first opening, the installing frame is installed at the first opening, the installing frame is provided with a second opening opposite to the first opening, and the cutting disk is slidably inserted into the installing frame to open or close the first opening and the second opening; and an auxiliary cutting assembly, detachably installed on the installing frame, wherein the auxiliary cutting assembly can limit a cutting position of a cutter to cut bread slices of a preset thickness. The storage box has the function of storing the bread slices.

### TECHNICAL FIELD

The present invention relates to the technical field of kitchenware, in particular to a bread slicer.

### BACKGROUND OF THE PRESENT INVENTION

In the prior art, the bread slicer can cut bread slices of uniform thickness, but when the bread is sliced, if the bread slices are not eaten immediately, it is necessary to find another tool to store the bread slices, which brings inconvenience to users.

In addition, the bread slicer in the prior art also includes a breadcrumb seat and a load-bearing frame placed on the breadcrumb seat. The load-bearing frame is used to carry bread, and the crumbs generated by cutting the bread can be leaked onto the breadcrumb seat through the load-bearing frame, so as to collect bread crumbs through the breadcrumb seat, but the installation of the load-bearing frame has the problems of unstable installation and difficult installation.

### SUMMARY OF PRESENT INVENTION

A purpose of the present invention i to provide a bread slicer to solve at least one of the above technical problems.

To achieve the above purpose, the present invention provides a bread slicer, comprising:
a storage box, comprising a box body, an installing frame and a cutting disk, wherein the box body is provided with an accommodating chamber, the accommodating chamber can accommodate cut bread slices, an upper end of the accommodating chamber has a first opening, the installing frame is installed at the first opening, the installing frame is provided with a second opening opposite to the first opening, and the cutting disk is slidably inserted into the installing frame to open or close the first opening and the second opening;
an auxiliary cutting assembly, detachably installed on the installing frame, wherein the auxiliary cutting assembly can limit a cutting position of a cutter to cut bread slices of a preset thickness.

Optionally, the installing frame comprises a first slot, the first slot comprises side guide surfaces and a supporting surface, at least part of a side wall of the first slot forms the side guide surfaces, and at least the bottom of the first slot forms the supporting surface;

The side guide surfaces can slidably guide the cutting disk, and a lower surface of the cutting disk is slidably abutted against the supporting surface.

Optionally, two side guide surfaces are arranged; the two side guide surfaces are arranged opposite to each other along a first direction; the two side guide surfaces are tilted from top to bottom away from each other; and the first direction, the slidable inserting direction of the cutting disk and a vertical direction are perpendicular pairwise;

First inserting parts are arranged on both sides of the cutting disk along the first direction, and the side surfaces of the two first inserting parts are tilted from top to bottom away from each other; the first inserting parts can be inserted on lower sides of the side guide surfaces; and the side surfaces of the first inserting parts are opposite to the side guide surfaces.

Optionally, the installing frame further comprises a second slot, the cutting disk is provided with a second inserting part, and the second inserting part can be inserted in the second slot to limit the cutting disk to separate from the first slot along the vertical direction;

The side guide surfaces are located at a first end of the bread slicer, the second slot is located at a second end of the bread slicer, and the first end and the second end are arranged along the slidable inserting direction.

Optionally, the lower side of the cutting disk is also connected with a limiting sheet, the limiting sheet is located in the second opening, and the limiting sheet is arranged opposite to an inner wall of the installing frame and can guide the sliding of the cutting disk.

Optionally, both ends of the cutting disk along the first direction are connected with the limiting sheet.

Optionally, the installing frame comprises an outer border and a positioning flange connected to the outer border, the outer border can be inserted into the first opening, and the positioning flange can be abutted against an upper end surface of the box body.

Optionally, the installing frame further comprises third slots, and the auxiliary cutting assembly is detachably inserted into the third slots.

Optionally, the auxiliary cutting assembly comprises a baffle plate and two cutting comb rows; the two cutting comb rows are detachably connected to the installing frame along the first direction; the cutting comb rows are provided with a plurality of cutting combs at intervals; one end of the baffle plate is detachably inserted between two adjacent cutting combs of one cutting comb row; the other end is detachably inserted between two adjacent cutting combs of the other cutting comb row; and the cutter can be inserted between two adjacent cutting combs.

Optionally, the cutting disk is spaced from the lower end of the baffle plate.

It can be seen from the above that in the technical solution provided by the present invention, when bread needs to be cut, the cutting disk is inserted into the installing frame; the first opening and the second opening are closed; the auxiliary cutting assembly is installed on the installing frame; the bread is placed on the cutting disk; and the bread slices of the preset thickness are cut out through the cutter and the auxiliary cutting assembly. Subsequently, the cutting disk slides to open the first opening and the second opening, and the bread slices enter the accommodating chamber through the first opening and the second opening. The cutting disk is slidably inserted again, the first opening and the second opening are closed, the bread slices are stored in the closed accommodating chamber, and the auxiliary cutting assembly is removed. The storage box has the function of storing the bread slices. After the bread is sliced, if the bread slices are not eaten immediately, the bread slices can be stored in the storage box to facilitate users to store the bread slices.

The cutting disk is connected to the installing frame by sliding insertion, which can facilitate the installation of the cutting disk and ensure the stability of the installation of the cutting disk.

### DESCRIPTION OF THE DRAWINGS

FIG. 1 is a structural schematic diagram of a bread slicer (a cutting disk closes a first opening and a second opening) provided by an embodiment of the present invention;

FIG. 2 is a structural schematic diagram of a bread slicer (a cutting disk opens a first opening and a second opening) provided by an embodiment of the present invention;

FIG. 3 is a structural schematic diagram of a storage box provided by an embodiment of the present invention;

FIG. 4 is a structural schematic diagram of an installing frame provided by an embodiment of the present invention;

FIG. 5 is a structural schematic diagram of an installing frame from another perspective provided by an embodiment of the present invention;

FIG. 6 is a partial enlarged view of A in FIG. 3;

FIG. 7 is a structural schematic diagram of a front side of a cutting disk provided by an embodiment of the present invention;

FIG. 8 is a structural schematic diagram of a back side of a cutting disk provided by an embodiment of the present invention;

FIG. 9 is a structural schematic diagram of connection between an installing frame and a cutting disk provided by an embodiment of the present invention;

FIG. 10 is a partial enlarged view of B in FIG. 9;

FIG. 11 is a sectional view of a bread slicer provided by an embodiment of the present invention;

FIG. 12 is a partial enlarged view of C in FIG. 11;

FIG. 13 is a sectional view of another position of a bread slicer provided by an embodiment of the present invention;

FIG. 14 is a partial enlarged view of D in FIG. 13;

FIG. 15 is a structural schematic diagram of a cutting comb row provided by an embodiment of the present invention.

In the figures:
10, storage box;
1, box body; 11, accommodating chamber;
2, installing frame; 21, second opening; 22, first slot; 221, side guide surface; 222, supporting surface; 23, outer border; 24, positioning flange; 25, second slot; 26, first inner border; 27, first connecting plate; 28, second inner border; 29, second connecting plate; 201, third slot;
3, cutting disk; 31, third end; 32, fourth end; 33, first inserting part; 34, second inserting part; 35, limiting sheet;
4, auxiliary cutting assembly; 41, cutting comb row; 411, connecting part; 412, cutting comb; 42, baffle plate;
5, first end; 6, second end.

### DETAILED DESCRIPTION OF PREFERRED EMBODIMENTS

The technical solution of the present invention is further explained below in combination with drawings and through specific embodiments. It is understood that the specific embodiments described herein are intended only to explain the present invention and not to limit the present invention. It should also be noted that, for ease of description, only the parts related to the present invention, but not all, are shown in the drawings.

The present invention limits some positional words, and in the absence of contrary explanations, the used positional words, such as “up”, “down”, “left”, “right”, “inner” and “outer”, are adopted for easy understanding, and therefore do not constitute a limitation on the protection scope of the present invention.

In the present invention, unless otherwise clearly specified and defined, a first feature is “above” or “below” a second feature comprises that the first feature and the second feature come into direct contact or the first feature and the second feature come into contact through additional features thereof instead of direct contact. Moreover, the first feature is “on”, “above” and “over” the second feature comprises that the first feature is directly above or slightly above the second feature, or just indicates that the horizontal height of the first feature is higher than that of the second feature. The first feature is “under”, “below” and “beneath” the second feature comprises that the first feature is directly below or slightly below the second feature, or just indicates that the horizontal height of the first feature is lower than that of the second feature.

In the explanation of the present invention, unless otherwise specifically regulated and defined, terms such as “connected”, “connecting” and “fixation” shall be understood in broad sense, and for example, may refer to fixed connection or detachable connection or integral connection, may refer to mechanical connection or electrical connection, and may refer to direct connection or indirect connection through an intermediate medium or inner communication of two elements or interaction relationship of two elements. For those ordinary skilled in the art, the specific meanings of the above terms in the present invention may be understood according to concrete conditions.

The present embodiment provides a bread slicer for cutting bread slices and storing the bread slices to facilitate the users to store the bread slices.

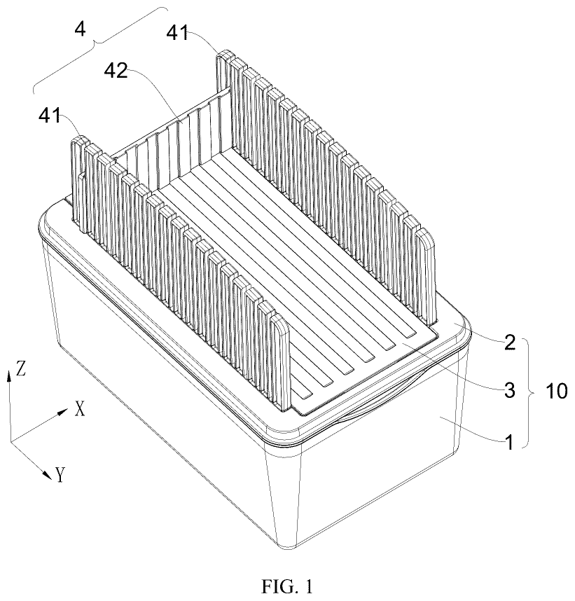

As shown in FIG. 1-FIG. 3, the bread slicer provided in the present embodiment comprises a storage box 10 and an auxiliary cutting assembly 4. When bread is cut, the storage box 10 can carry the bread so that the auxiliary cutting assembly 4 can be used to cut the bread into bread slices of the same thickness. After the bread is cut, the bread slices can be stored through the storage box 10.

Specifically, the storage box 10 comprises a box body 1, an installing frame 2 and a cutting disk 3. The box body 1 is provided with an accommodating chamber 11, the accommodating chamber 11 can accommodate cut bread slices, an upper end of the accommodating chamber 11 has a first opening, the installing frame 2 is installed at the first opening, the installing frame 2 is provided with a second opening 21 opposite to the first opening, and the cutting disk 3 is slidably inserted into the installing frame 2 to open or close the first opening and the second opening 21. The auxiliary cutting assembly 4 is detachably installed on the installing frame 2, and the auxiliary cutting assembly 4 can limit a cutting position of a cutter to cut bread slices of a preset thickness.

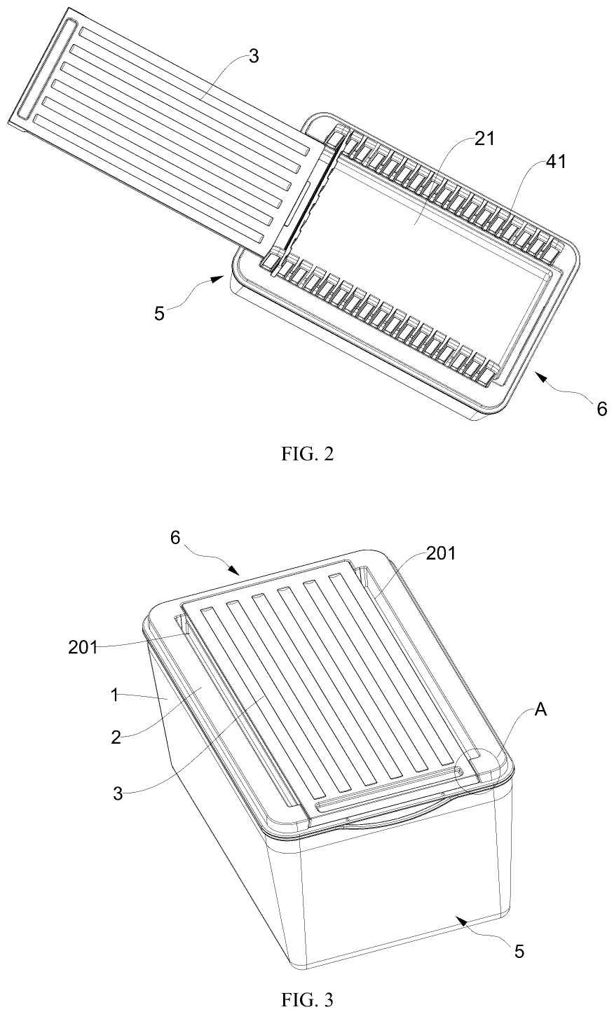

As shown in FIG. 1, when bread needs to be cut, the cutting disk 3 is inserted into the installing frame 2; the first opening and the second opening 21 are closed; the auxiliary cutting assembly 4 is installed on the installing frame 2; the bread is placed on the cutting disk 3; and the bread slices of the preset thickness are cut out through the cutter and the auxiliary cutting assembly 4. As shown in FIG. 2, subsequently, the cutting disk 3 slides to open the first opening and the second opening 21, and the bread slices enter the accommodating chamber 11 through the first opening and the second opening 21. As shown in FIG. 3, the cutting disk 3 is slidably inserted again, the first opening and the second opening 21 are closed, the bread slices are stored in the closed accommodating chamber 11, and the auxiliary cutting assembly 4 is removed. The storage box 10 has the function of storing the bread slices. After the bread is sliced, if the bread slices are not eaten immediately, the bread slices can be stored in the storage box 10 to facilitate users to store the bread slices.

The cutting disk 3 is connected to the installing frame 2 by sliding insertion, which can facilitate the installation of the cutting disk 3 and ensure the stability of the installation of the cutting disk 3.

It is understood that the cutting disk 3 has no hole, to close the accommodating chamber 11 when the first opening and the second opening 21 are closed, so as to prevent bread crumbs and bread slices from falling out of the accommodating chamber 11.

As shown in FIGS. 3-8, the installing frame 2 comprises a first slot 22, the first slot 22 comprises side guide surfaces 221 and a supporting surface 222, at least part of a side wall of the first slot 22 forms the side guide surfaces 221, and at least the bottom of the first slot 22 forms the supporting surface 222; the side guide surfaces 221 can slidably guide the cutting disk 3, and a lower surface of the cutting disk 3 is slidably abutted against the supporting surface 222. The side guide surfaces 221 and the supporting surface 222 allow the cutting disk 3 to slide stably. The side guide surfaces 221 can also prevent the cutting disk 3 from tilting in the process of sliding, so as to ensure that the cutting disk 3 slides in place.

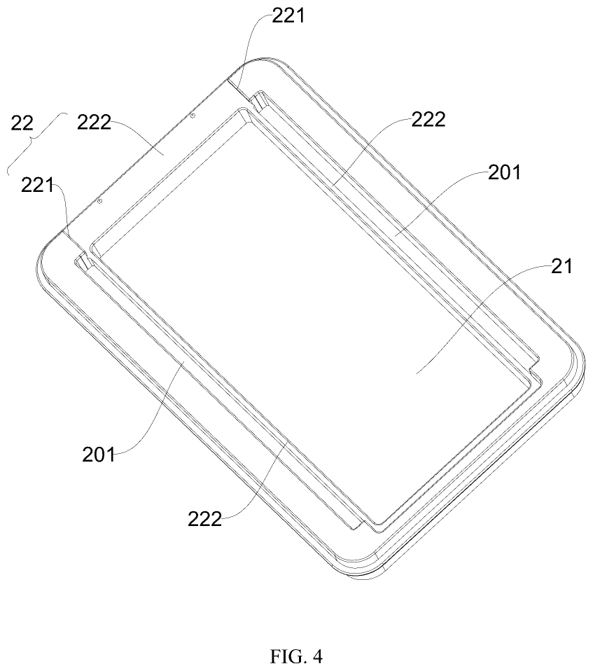

As shown in FIG. 4-FIG. 6, optionally, two side guide surfaces 221 are arranged; the two side guide surfaces 221 are arranged opposite to each other along a first direction X; and the two side guide surfaces 221 are tilted from top to bottom away from each other. Wherein the first direction X, the slidable inserting direction of the cutting disk 3 and a vertical direction Z are perpendicular pairwise.

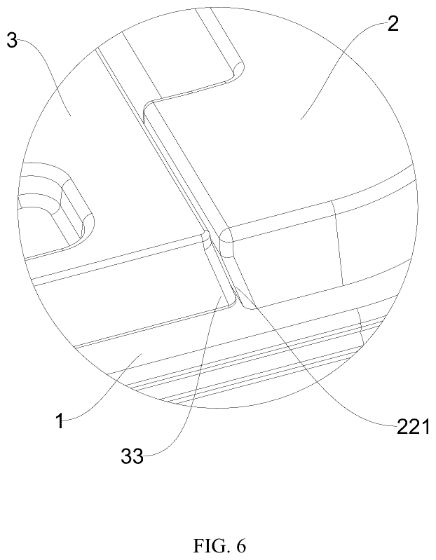

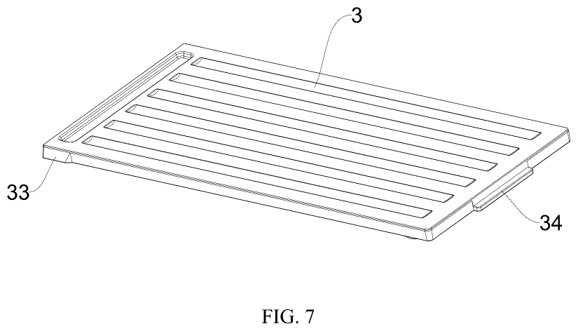

As shown in FIG. 6 and FIG. 7, first inserting parts 33 are arranged on both sides of the cutting disk 3 along the first direction X, and the side surfaces of the two first inserting parts 33 are tilted from top to bottom away from each other; the first inserting parts 33 can be inserted on lower sides of the side guide surfaces 221; and the side surfaces of the first inserting parts 33 are opposite to the side guide surfaces 221. The tilted side guide surfaces 221 and the first inserting part 33 can be used for limiting the cutting disk 3 to separate from the first slot 22, that is, limiting the cutting disk 3 to move up along the vertical direction Z to separate from the installing frame 2. Because the lower surface of the cutting disk 3 is abutted against the supporting surface 222, the supporting surface 222 limits the cutting disk 3 to move up along the vertical direction Z. Therefore, after the cutting disk 3 is inserted in place, the tilted side guide surfaces 221 and the supporting surface 222 can be used for limiting the cutting disk 3 to move along the vertical direction Z, so that the cutting disk 3 may not open the first opening and the second opening 21 when the storage box 10 is tossed or inverted.

Optionally, the side guide surfaces 221 are located at a first end 5 of the bread slicer (as shown in FIG. 2 and FIG. 3). Preferably, the first end 5 is an end where the cutting disk 3 is inserted into the installing frame 2, so that the side guide surfaces 221 can guide the cutting disk 3 in the entire process that the cutting disk 3 is inserted into the installing frame 2, so as to prevent the cutting disk 3 from deflecting in the first direction X.

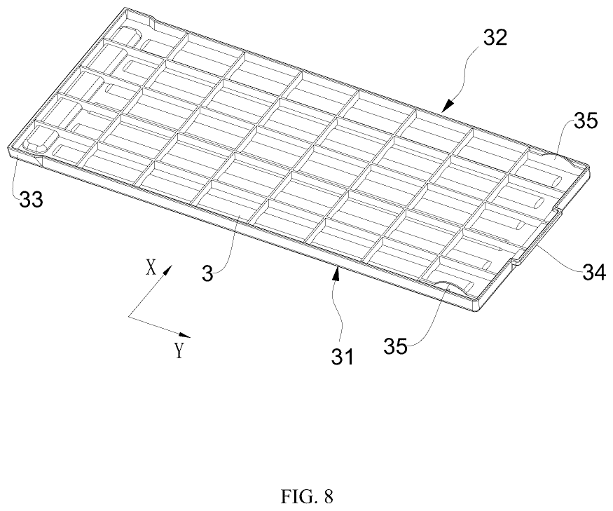

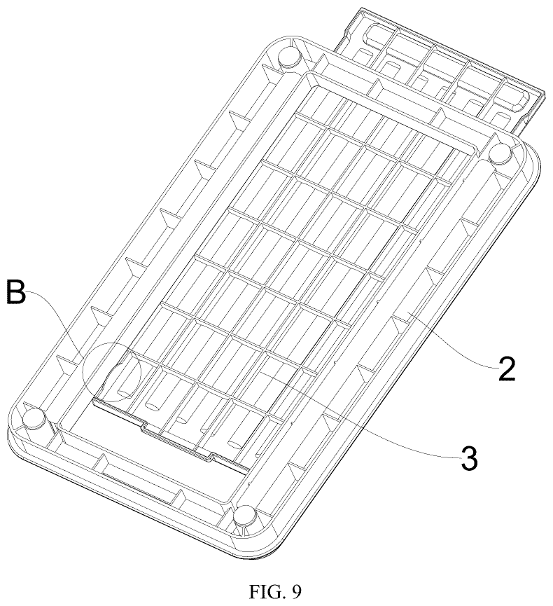

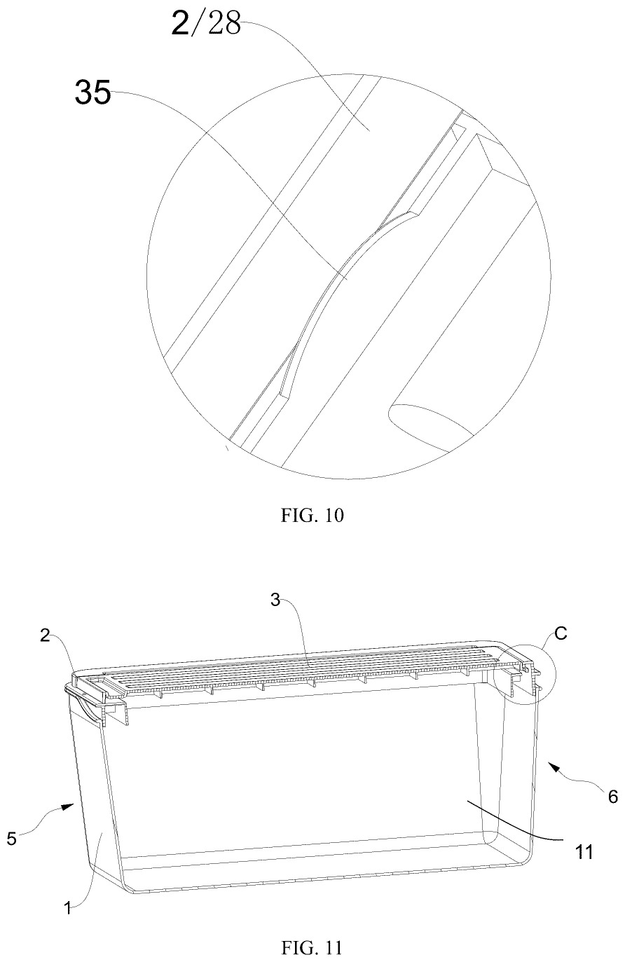

As shown in FIGS. 8-10, the lower side of the cutting disk 3 can also be connected with a limiting sheet 35, the limiting sheet 35 is located in the second opening 21, and the limiting sheet 35 is arranged opposite to an inner wall of the installing frame 3 and can guide the sliding of the cutting disk 3. In the process of inserting the cutting disk 3, if the cutting disk 3 is tilted in the first direction X, the limiting sheet 35 can be abutted against the inner wall of the cutting disk 3, thereby limiting the continuing tilting of the cutting disk 3 and thus achieving the role of guiding the cutting disk 3.

Optionally, the cutting disk 3 has a roughly rectangular structure, and the length direction of the cutting disk 3 is consistent with the slidable inserting direction Y of the cutting disk 3. Exemplarily, the limiting sheet 35 may be located roughly at one end of the cutting disk 3 along the slidable inserting direction Y, and the first inserting part 33 may be located at the other end of the cutting disk 3 along the slidable inserting direction Y. After the cutting disk 3 has slides in place (the first opening and the second opening 21 are closed), the first inserting part 33 is located at the first end 5 of the bread slicer. The limiting sheet 35 is located at the second end 6 of the bread slicer, wherein the first end 5 and the second end 6 are arranged along the slidable inserting direction Y. In the process of slidable insertion of the cutting disk 3, the limiting sheet 35 and the side guide surfaces 221 are used for guiding, to ensure that the cutting disk 3 is inserted into the installing frame 2 along the slidable inserting direction Y, thereby ensuring that the cutting disk 3 is inserted in place.

As shown in FIG. 8, the cutting disk 3 is connected with the limiting sheets 35 at both ends of the first direction X, so that the limiting sheet 35 can realize limiting and guiding regardless of whether the cutting disk 3 is tilted in the first direction X to either side.

Specifically, for ease of illustration, one limiting sheet 35 is connected to the third end 31 of the cutting disk 3, and the other limiting sheet 35 is connected to the fourth end 32 of the cutting disk 3. The third end 31 and the fourth end 32 are spaced along the first direction X. When the cutting disk 3 is tilted along the first direction X to the side where the third end 31 is located, the limiting sheet 35 located at the third end 31 can be abutted against the inner wall of one side of the installing frame 2 to prevent the cutting disk 3 from continuing to tilt. When the cutting disk 3 is tilted along the first direction X to a side where the fourth end 32 is located, the limiting sheet 35 located at the fourth end 32 can be abutted against the inner wall of the other side of the installing frame 2 to prevent the cutting disk 3 from continuing to tilt.

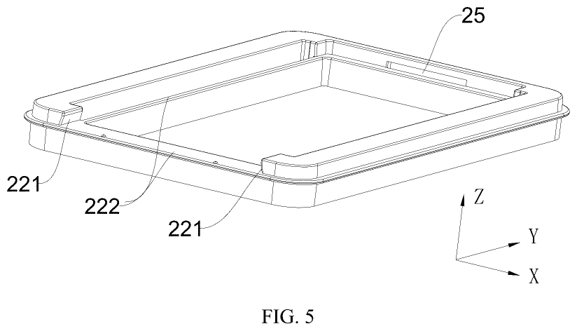

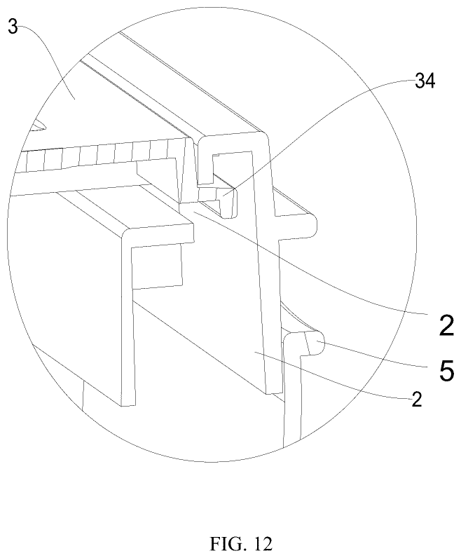

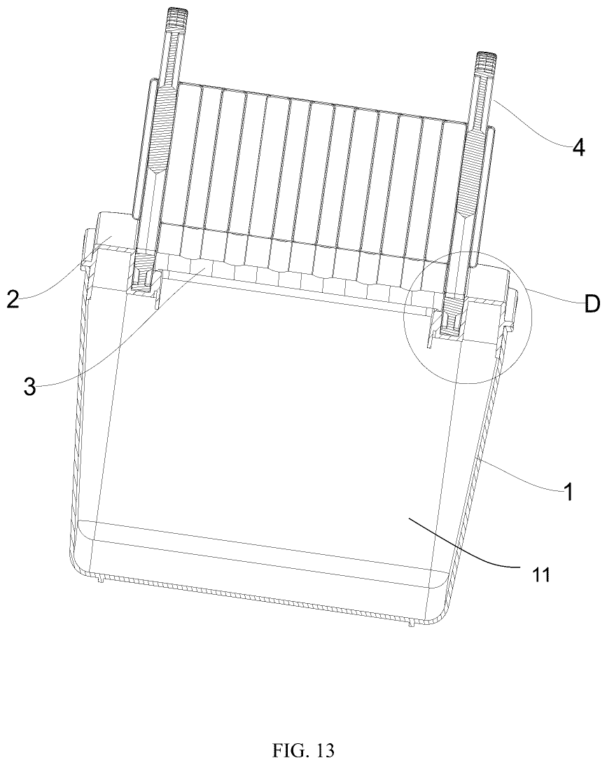

As shown in FIG. 5, the installing frame 2 can also comprise a second slot 25. As shown in FIG. 7 and FIG. 8, the cutting disk 3 is provided with a second inserting part 34. As shown in FIG. 11 and FIG. 12, the second inserting part 34 can be inserted in the second slot 25 to limit the cutting disk 3 to separate from the first slot 22 along the vertical direction Z, so as to limit the cutting disk 3 to separate from the installing frame 2 along the vertical direction Z.

The second slot 25 may be located at the second end 6 of the bread slicer 6. When the cutting disk 3 slides in place (the first opening and the second opening 21 are closed), the second inserting part 34 is inserted into the second slot 25. Accordingly, the second inserting part 34 is located at one end of the cutting disk 3 along the slidable inserting direction Y, and the first inserting part 33 is located at the other end of the cutting disk 3 along the slidable inserting direction Y.

On the one hand, the second slot 25 is located at the second end 6 of the bread slicer, and the cutting disk 3 can be fixed on the premise that the second inserting part 34 does not interfere with the sliding of the cutting disk 3. On the other hand, the second slot 25 and the side guide surfaces 221 are arranged at both ends of the installing frame 2 along the slidable inserting direction Y, thereby limiting the movement of the cutting disk 3 along the vertical direction Z at both ends, and thus better limiting the removal of the cutting disk 3 from the installing frame 2.

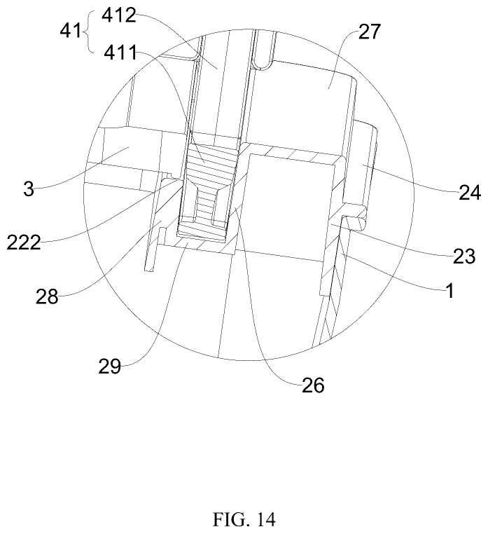

As shown in FIG. 13 and FIG. 14, the installing frame 2 comprises an outer border 23 and a positioning flange 4 connected to the outer border 23. The outer border 23 can be inserted into the first opening, and the positioning flange 4 can be abutted against the upper end surface of the box body 1, so that the installing frame 2 is installed on the box body 1.

Optionally, the outer border 23 is arranged along the circumferential direction of the installing frame 2, and the outer border 23 can be in contact with the inner wall of the box body 1. Thus, after the outer border 23 is inserted into the box body 1, the installing frame 2 is not easily separated from the box body 1.

Exemplarily, the installing frame 2 can also comprise a first inner border 26 and a first connecting plate 27; the upper ends of the first inner border 26 and the outer border 23 are connected to the first connecting plate 27; and the first inner border 26 and the outer border 23 are spaced, and enclosed with the first connecting plate 27 to form a U-shaped structure with a downward opening. Because the first inner border 26 and the outer border 23 are spaced, on the one hand, the outer border 23 can be tilted inward when the box body 1 is inserted, to smoothly insert the box body 1. On the other hand, the weight of the installing frame 2 can be reduced, to save materials and reduce cost.

Optionally, the installing frame 2 may also comprise a second inner border 28 and a second connecting plate 29; the lower ends of the first inner border 26 and the second inner border 28 are connected to the second connecting plate 29; and the first inner border 26 and the second inner border 28 are spaced, and enclosed with the second connecting plate 29 to form a U-shaped structure with an upward opening. Optionally, the upper surface of the second inner border 28 forms part of the supporting surface 222, and the lower surface of the cutting disk 3 is abutted against the upper surface of the second inner border 28. Exemplarily, the limiting sheet 35 is arranged opposite to the second inner border 28.

As shown in FIG. 4, optionally, the installing frame 2 may also comprise third slots 201, and the auxiliary cutting assembly 4 is detachably inserted into the third slots 201. The auxiliary cutting assembly 4 is installed by insertion to facilitate the installation and disassembly of the auxiliary cutting assembly 4, so as to improve installation and disassembly efficiency, and facilitate operation of users.

Exemplarily, as shown in FIG. 13 and FIG. 14, the first inner border 26, the second inner border 28 and the second connecting plate 29 are enclosed to form a U-shaped structure with an upward opening, i.e., a third slot 201, and the lower end of the auxiliary cutting assembly 4 is inserted into the U-shaped structure with the upward opening.

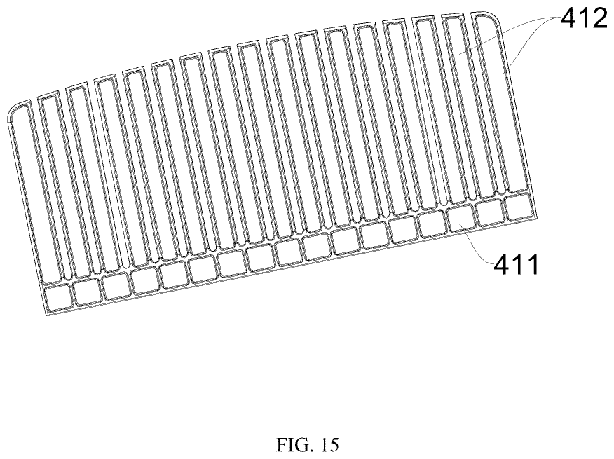

As shown in FIG. 15 and in conjunction with FIG. 1 and FIG. 13, the auxiliary cutting assembly 4 comprises a baffle plate 42 and two cutting comb rows 41, and the two cutting comb rows 41 are detachably connected to the installing frame 2 along the first direction X. Optionally, the installing frame 2 is provided with the third slots 201 at intervals along the first direction X, and one cutting comb row 41 is inserted into one third slot 201.

As shown in FIG. 14 and FIG. 15, and in conjunction with FIG. 1, the cutting comb rows 41 have a plurality of cutting combs 412 arranged at intervals; one end of the baffle plate 42 is detachably inserted between two adjacent cutting combs 412 of one cutting comb row 41; and the other end is detachably inserted between two adjacent cutting combs 412 of the other cutting comb row 41. The cutter can be inserted between two adjacent cutting combs 412, so that the cutter penetrates through two adjacent cutting combs 412 to cut bread.

Optionally, the cutting comb rows 41 may also comprise connecting parts 411, the lower ends of a plurality of cutting combs 412 are connected to the connecting parts 411, and the connecting parts 411 are inserted into the third slots 201.

Optionally, the cutting disk 3 is spaced from the lower end of the baffle plate 42 so that after the bread is cut, the cutting disk 3 is drawn out and the first opening and the second opening 21 are opened without disassembling the auxiliary cutting assembly 4.

The baffle plate 42 is preferably inserted at the inserting end of the cutting comb rows 41 near the cutting disk 3. In this way, when the cutting disk 3 is drawn out, the bread slices located on the cutting disk 3 can be abutted against the baffle plate 42. Under the stop effect of the baffle plate 42, in the process of gradually drawing out the cutting disk 3, the bread slices fall into the accommodating chamber 11 one by one, without the need of contacting the bread slices by human hands.

Although the present invention has been described in detail above by general explanation, specific embodiments and tests, it is obvious to those skilled in the art that some modifications or improvements can be made on the basis of the present invention. Therefore, these modifications or improvements made without deviating from the spirit of the present invention belong to the protection scope of the present invention.

1. A bread slicer, comprising:
a storage box, comprising a box body, an installing frame and a cutting disk, wherein the box body is provided with an accommodating chamber, the accommodating chamber is configured to accommodate cut bread slices, an upper end of the accommodating chamber has a first opening, the installing frame is installed at the first opening, the installing frame is provided with a second opening opposite to the first opening, and the cutting disk is slidably inserted into the installing frame to open or close the first opening and the second opening;
an auxiliary cutting assembly, detachably installed on the installing frame, wherein the auxiliary cutting assembly is configured to limit a cutting position of a cutter to cut bread slices of a preset thickness;
wherein the installing frame comprises a first slot, the first slot comprises side guide surfaces and a supporting surface, at least a part of a side wall of the first slot forms the side guide surfaces, and at least a bottom of the first slot forms the supporting surface;
the side guide surfaces are configured to slidably guide the cutting disk, and a lower surface of the cutting disk is slidably abutted against the supporting surface;
wherein the lower side of the cutting disk is also connected with limiting sheets, the limiting sheets are located in the second opening, and the limiting sheets are arranged opposite to an inner wall of the installing frame to guide the sliding of the cutting disk; and
the limiting sheets are respectively connected to two ends of the cutting disk along a first direction (X);
each of two sides, along the first direction (X), of the installing frame comprises a second slot extending along a slidable inserting direction (Y) of the cutting disk; the auxiliary cutting assembly comprises a baffle plate and two cutting comb rows; each of the two cutting comb rows comprises a plurality of cutting combs at intervals and a connection part, lower ends of the plurality of the cutting bombs are connected to the connecting part, and the connecting part is configured to be inserted into the second slot of the installing frame; each of two ends of the baffle plate is configured to be detachably inserted between two adjacent cutting combs of a corresponding one of the two cutting comb rows; and the cutter is configured to be inserted between two adjacent cutting combs.

2. (canceled)

3. The bread slicer according to claim 1, wherein a number of the side guide surfaces is two; the two side guide surfaces are arranged opposite to each other along the first direction (X); the two side guide surfaces are tilted from top to bottom away from each other; and the first direction (X), the slidable inserting direction (Y) of the cutting disk and a vertical direction (Z) are perpendicular pairwise;
first inserting parts are arranged on both sides of the cutting disk along the first direction (X), and the side surfaces of the two first inserting parts are tilted from top to bottom away from each other; the first inserting parts is inserted on lower sides of the side guide surfaces; and the side surfaces of the first inserting parts are opposite to the side guide surfaces.

4. The bread slicer according to claim 3, wherein the installing frame further comprises a third slot, the cutting disk is provided with a second inserting part, and the second inserting part is inserted in the third slot to limit the cutting disk to separate from the first slot along the vertical direction (Z);
the side guide surfaces are located at a first end of the bread slicer, the third slot is located at a second end of the bread slicer, and the first end and the second end are arranged along the slidable inserting direction (Y).

5. (canceled)

6. (canceled)

7. The bread slicer according to claim 1, wherein the installing frame comprises an outer border and a positioning flange connected to the outer border, the outer border is inserted into the first opening, and the positioning flange is abutted against an upper end surface of the box body.

8. (canceled)

9. (canceled)

10. The bread slicer according to claim 1, wherein the cutting disk is spaced from a lower end of the baffle plate.
